(19) United States
(12) Patent Application Publication
(10) Pub. No.: US 2002/0038940 A1
(43) Pub. Date: Apr. 4, 2002

(54) Flexible ski loop system

(76) Inventor: Dale D. Cormican, Mentor, MN (US)

Correspondence Address: Michael S. Neustel, Suite No. 4, 2534 South University Drive, Fargo, ND, 58103, US

(21) Appl. No.: 10/003,828

(22) Filed: Oct. 31, 2001

Related U.S. Application Data
(63) Continuation-in-part of application No. 09/130,892, filed on Aug. 7, 1998.
(63) Continuation-in-part of application No. 09/935,080, filed on Aug. 21, 2001.

(51) Int. Cl. A63C 5/07; B62M 27/02

(52) U.S. Cl. 280/22

(57) ABSTRACT

A flexible ski loop system for allowing a loop member for a ski to easily pivot at opposing ends thereof. The flexible ski loop system comprises a ski having an elongate body having a front portion, middle portion and a rear portion, a receiver cavity within the front end of the front portion, a front aperture extending through the front end within the receiver cavity, a loop member having a first end pivotally attached to a middle portion of the elongate body by a first fastener and a second end pivotally attached within the receiver cavity by a second fastener. The receiver cavity has a curved structure and the second end of the loop member has a curved end that is pivotally positionable within the receiver cavity. The front aperture is preferably broader in diameter than the second fastener thereby allowing movement of the second fastener when the second end of the loop member is pivoted within the receiver cavity.

### CROSS-REFERENCE TO RELATED U.S. PATENT APPLICATION

I hereby claim benefit under Title 35, U.S. Code, Section 120 of U.S. patent applications Ser. No. 09/130,892 (filed Aug. 7, 1998) and Ser. No. 09/935,080 (filed Aug. 21, 2001). This application is a continuation-in-part of the Ser. No. 09/130,892 and Ser. No. 09/935,080 applications. The Ser. No. 09/130,892 application and Ser. No. 09/935,080 application are currently pending. The Ser. No. 09/130,892 application and the Ser. No. 09/935,080 application are hereby incorporated by reference into this patent application.

### BACKGROUND OF THE INVENTION

1. Field of the Invention

The present invention relates generally to skis for use upon snowmobiles and like vehicles that operate upon snow, and more specifically it relates to a flexible ski loop system for allowing a loop member to easily pivot at opposing ends thereof.

2. Description of the Prior Art

Skis for snowmobiles and like vehicles have been in use for years. A snowmobile or like vehicle typically is comprised of a frame, a track within the rear portion of the vehicle, and a pair of skis controllably attached to a steering structure of the vehicle. Skis are utilized for supporting and steering the vehicle during operation upon snow and other surfaces. Skis are generally comprised of plastic, or a combination of metal and plastic. Skis typically have an elongate body, a rigid metal saddle attached to the upper surface of the elongate body, and a loop member having a first end and a second attached between a middle portion and a front end portion of the ski.

The main problem with conventional skis is that the loop member is rigidly and non-movably attached to the front end portion of the ski thereby interfering with the natural flexing movement of the loop member. Another problem with conventional skis is that the rigid attachment of the loop member to the front end portion reduces the ability of the loop member to flex when encountering obstacles and rough terrain. Conventional skis provide an overall relatively rough ride for the operator of a snowmobile which reduces both rider enjoyment and handling of the ski.

While conventional ski manufacturing processes may be suitable for the particular purpose to which they address, they are not as suitable for allowing a loop member for a ski to easily pivot at opposing ends thereof. Conventional skis rigidly attached the loop member to the front end portion of the ski thereby limiting movement and flexing of the loop member.

In these respects, the flexible ski loop system according to the present invention substantially departs from the conventional concepts and designs of the prior art, and in so doing provides an apparatus primarily developed for the purpose of allowing a loop member to easily pivot at opposing ends thereof with respect to a ski.

### SUMMARY OF THE INVENTION

In view of the foregoing disadvantages inherent in the known types of skis and ski manufacturing processes now present in the prior art, the present invention provides a new flexible ski loop system wherein the same can be utilized for allowing a loop member for a ski to easily pivot at opposing ends thereof.

The general purpose of the present invention, which will be described subsequently in greater detail, is to provide a new flexible ski loop system that has many of the advantages of the skis and method of manufacturing mentioned heretofore and many novel features that result in a new flexible ski loop system which is not anticipated, rendered obvious, suggested, or even implied by any of the prior art, either alone or in any combination thereof.

To attain this, the present invention generally comprises a ski having an elongate body having a front portion, middle portion and a rear portion, a receiver cavity within the front end of the front portion, a front aperture extending through the front end within the receiver cavity, a loop member having a first end pivotally attached to a middle portion of the elongate body by a first fastener and a second end pivotally attached within the receiver cavity by a second fastener. The receiver cavity has a curved structure and the second end of the loop member has a curved end that is pivotally positionable within the receiver cavity. The front aperture is preferably broader in diameter than the second fastener thereby allowing movement of the second fastener when the second end of the loop member is pivoted within the receiver cavity.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a flexible ski loop system that will overcome the shortcomings of the prior art devices.

A second object is to provide a flexible ski loop system for allowing a loop member for a ski to easily pivot at opposing ends thereof.

An additional object is to provide a flexible ski loop system that increases the overall performance of the ski in a variety of conditions.

A further object is to provide a flexible ski loop system that allows the front portion of the ski to flex rearwardly without significant resistance by the end connections of the loop member.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2 is a magnified upper perspective view of the present invention.

FIG. 3 is an upper perspective view of the present invention with the front end of the loop member removed from the front end portion of the ski.

FIG. 4 is a magnified upper perspective view of the present invention with the front end of the loop member removed from the front end portion of the ski.

FIG. 5 is a magnified top view of the present invention with the front end of the loop member removed from the front end portion of the ski.

FIG. 6 is a cross sectional view taken along line 6-6 of FIG. 5.

FIG. 7 is a cross sectional view taken along line 7-7 of FIG. 5.

FIG. 8 is a front end view of the present invention.

### DESCRIPTION OF THE PREFERRED EMBODIMENT

A. Overview

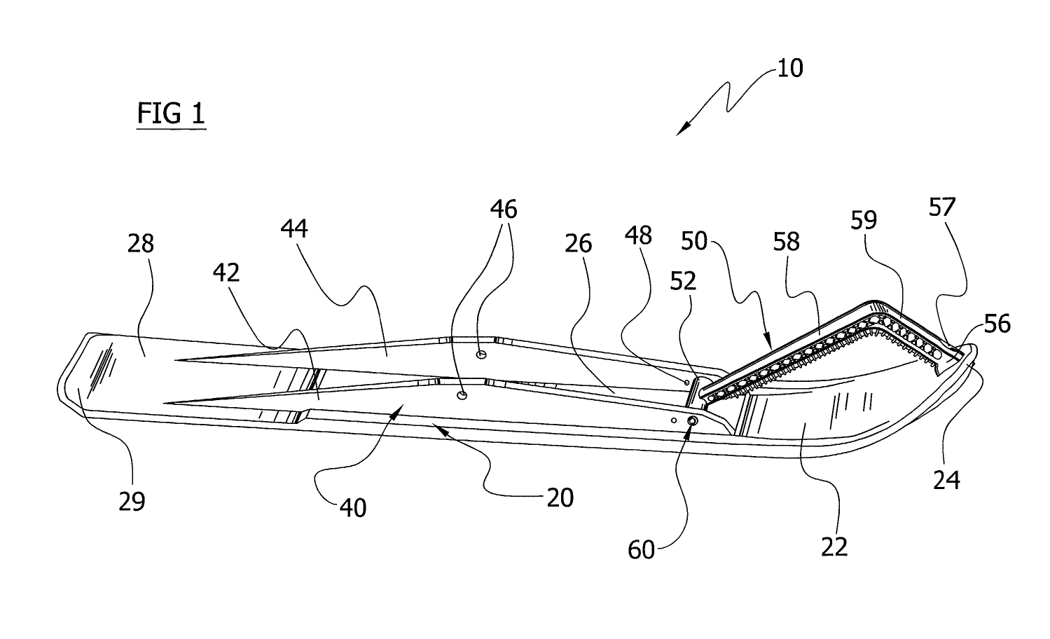

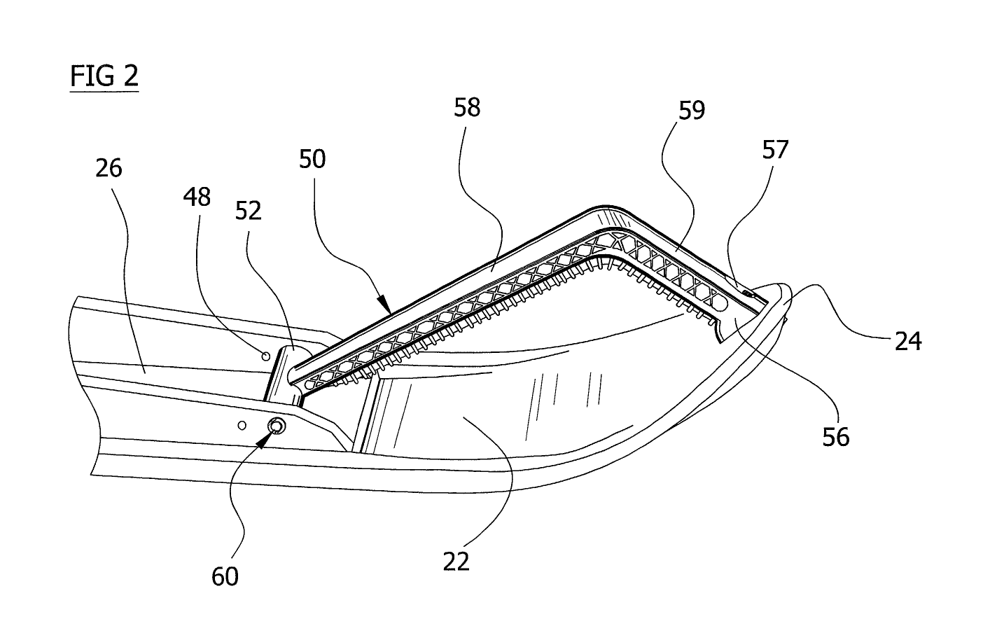

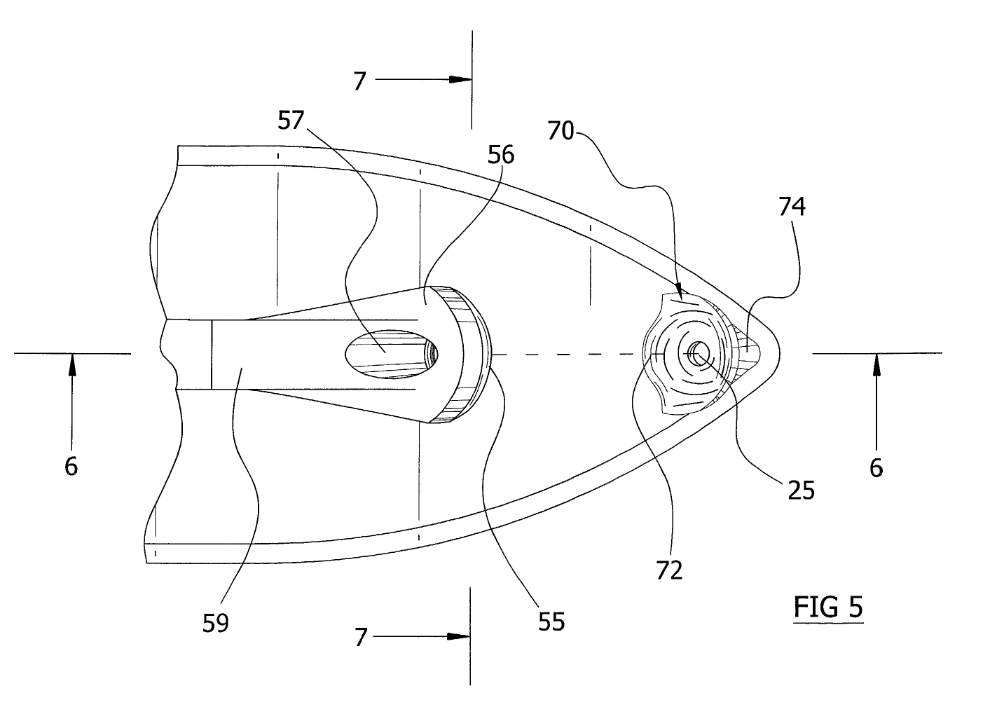

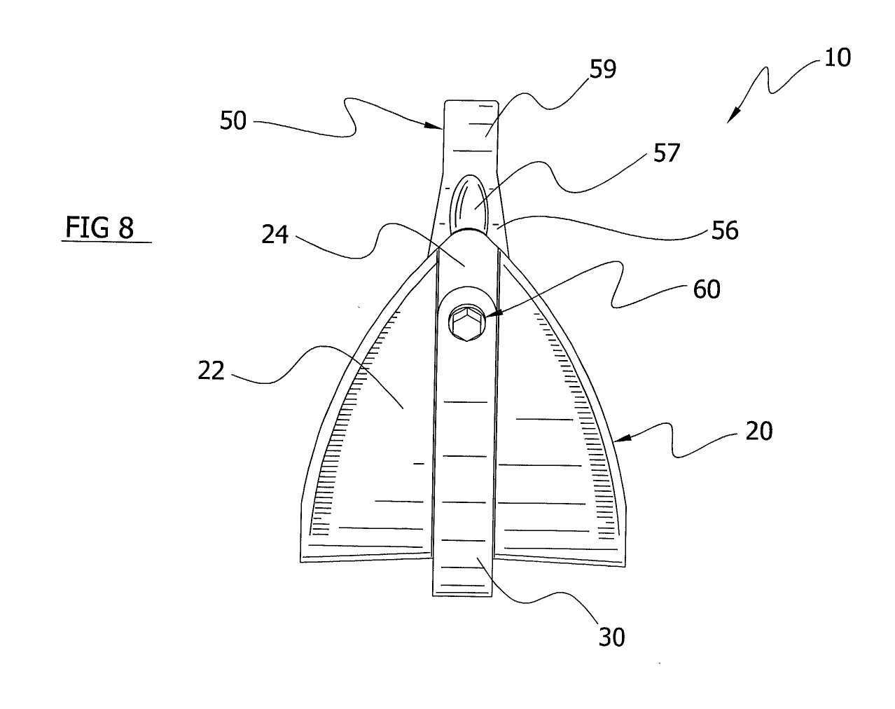

Turning now descriptively to the drawings, in which similar reference characters denote similar elements throughout the several views, FIGS. 1 through 8 illustrate a flexible ski loop system 10, which basically comprises a ski having an elongate body 20 having a front portion 22, middle portion 26 and a rear portion 28, a receiver cavity 70 within the front end 24 of the front portion 22, a front aperture 25 extending through the front end 24 within the receiver cavity 70, a loop member 50 having a first end 52 pivotally attached to a middle portion 26 of the elongate body 20 by a first fastener 60 and a second end 56 pivotally attached within the receiver cavity 70 by a second fastener 62. The receiver cavity 70 has a curved structure and the second end 56 of the loop member 50 has a curved end 55 that is pivotally positionable within the receiver cavity 70. The front aperture 25 is preferably broader in diameter than the second fastener 62 thereby allowing movement of the second fastener 62 when the second end 56 of the loop member 50 is pivoted within the receiver cavity 70.

B. Elongate Body

The elongate body 20 is preferably comprised of a resilient and flexible material such as but not limited to ultra high molecular weight (UHMW) polyethylene. It can be appreciated that various other types of resilient and flexible materials may be utilized to construct the elongate body 20. Furthermore, the elongate body 20 may be created utilizing various molding processes such as but not limited to injection molding and rotational molding. The elongate body 20 may be initially molded with the front portion 22 substantially straight, slanted or curved.

As further shown in FIG. 1 of the drawings, the elongate body 20 is basically comprised of a front portion 22 having a front end 24, a middle portion 26 and a rear portion 28 having a rear end 29. The elongate body 20 has a generally flat structure except for the saddle portion 40 and the keel member 30. It can be appreciated that the elongate body 20 may have various shapes other than a flat shape that are able to act as a ski. The elongate body 20 has an upper surface and a lower surface which are substantially parallel to one another which may have a varying or consistent thickness throughout.

As shown in FIG. 1 of the drawings, a saddle portion 40 extends upwardly from the upper surface of the elongate body 20. The saddle portion 40 is preferably molded integral within the elongate body 20, however the saddle portion 40 may be attached to the elongate body 20 by conventional fastening means. The saddle portion 40 extends from the middle portion 26 of the elongate body 20 thereby substantially defining the middle portion 26 of the elongate body 20 with the front portion 22 and the rear portion 28 on opposing ends of the saddle portion 40. The middle portion 26 may extend a finite distance past the distal ends of the saddle portion 40 as can be appreciated. The boundaries of the middle portion 26 therefore should not be limited to the area of the elongate body 20 supporting the saddle portion 40. It should be noted that the terminology front portion 22, middle portion 26 and rear portion 28 are merely utilized to illustrate the present invention and should not limit the scope of the invention.

The saddle portion 40 is preferably comprised of a first member 42 and a second member 44 extending substantially parallel to one another in a distally spaced relationship as is best illustrated in FIG. 1 of the drawings. Each member 42, 44 includes a main aperture 46 for receiving a pin member that secures the elongate body 20 to the front suspension of a snowmobile or like vehicle. The saddle portion 40 may have various shapes other than that illustrated within the drawings.

As shown in FIG. 1 of the drawings, the rear end 29 of the rear portion 28 is preferably curved for allowing the elongate body 20 to move rearwardly without catching upon the surface. However, it can be appreciated that the rear end 29 may have various other shapes such as but not limited to straight and slanted.

The rear portion 28, middle portion 26 and the front portion 22 define a substantially straight structure having a longitudinal axis extending from the rear portion 28 to the middle portion 26 of the elongate body 20, wherein the longitudinal axis is parallel to the upper surface of the middle portion 26 of the elongate body 20. The outer perimeter of the front portion 22 preferably is thicker than the central portion thereof for providing a warped structure when bent, however it can be appreciated that the front portion 22 may be comprised of a flat structure or variations thereof to achieve various results.

At least one pair of receiving apertures 48 extend through the saddle portion 40 in opposition to one another adjacent the front portion 22 of the elongate body 20 as further shown in FIG. 1 of the drawings. More than one pair of receiving apertures 48 is preferably utilized for allowing for the adjustment of the loop member 50. The receiving apertures 48 are formed for receiving a first fastener 60 extending through the first end 52 loop member 50 for pivotally securing the loop member 50 to the middle portion 26 of the elongate body 20. It can be appreciated that various other connection means may be utilized to secure the loop member 50 to the middle portion 26 of the elongate body 20 and the illustration of the receiving apertures 48 should not limit the scope of the invention. For example, the first end 52 the loop member 50 may be attached nonmovably or movably to the middle portion 26 of the elongate body 20 without being attached directly to the saddle portion 40.

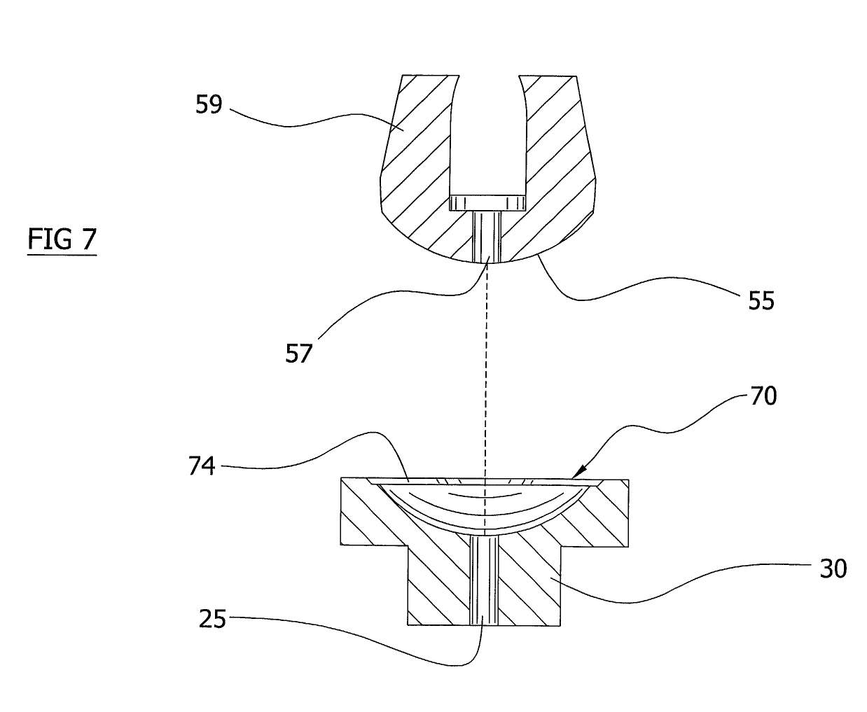

As shown in FIG. 7 of the drawings, at least one keel member 30 preferably extends from a lower surface of the elongate body 20 that is utilized for increasing the steering abilities of the finalized product. The keel member 30 may extend from or near the rear end 29 to the front portion 22 of the elongate body 20. The keel member 30 is preferably centered within the lower surface of the elongate body 20, however it can be appreciated that various other locations upon the elongate body 20 may be utilized particularly if multiple keel members 30 are utilized. The keel member 30 is preferably parallel to the longitudinal axis of the elongate body 20. The keel member 30 is preferably molded within the elongate body 20, however the keel member 30 may be removably attached thereto. In addition, the keel member 30 is preferably formed for receiving a wear rod member (not shown) commonly utilized upon snowmobile skis and the like for reducing wear upon the keel member 30 and the elongate body 20 during usage.

C. Loop Member

The loop member 50 is preferably comprised of a resilient and flexible material. The loop member may or may not create a preload within the front portion 22 of the elongate body 20. The loop member 50 may have various structures not illustrated within the attached figures. For example, the loop member 50 may have a first section with a straight structure and a second section with a curved structure. The loop member 50 may have an overall curved structure as is commonly utilized within the industry.

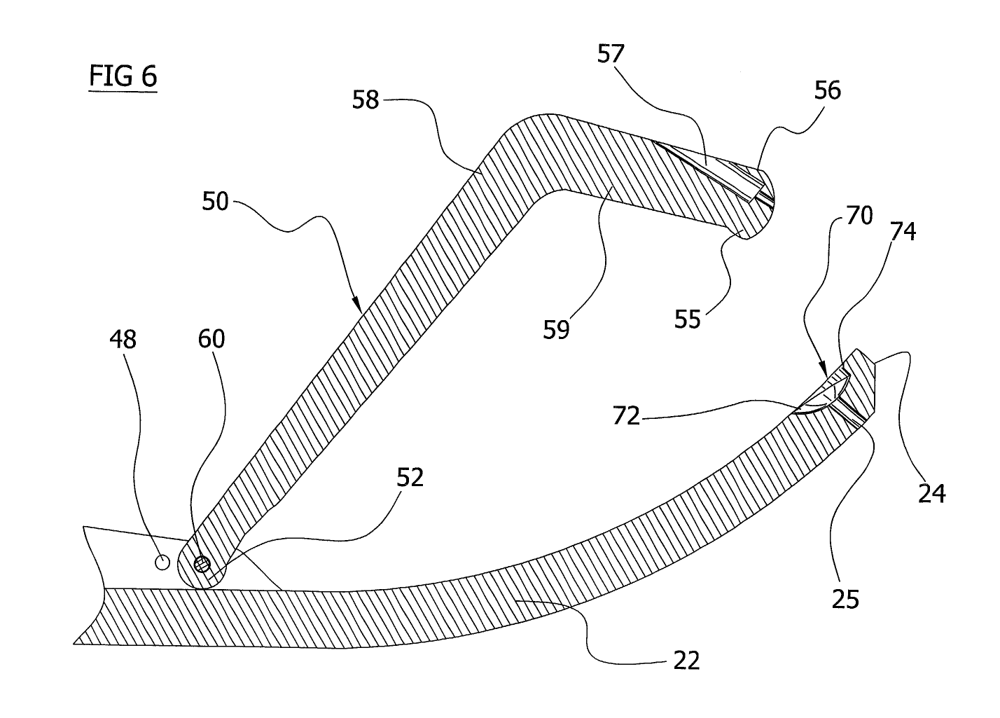

The inventor has determined that the best mode of manufacturing and operating the present invention is to mold a loop member 50 comprised of a first segment 58 and a second segment 59 wherein the segments 58, 59 are with respect to one another at an angle. The segments 58, 59 are preferably at least 90 degrees with respect to one another, however greater or less angles may be utilized to construct the loop member 50. In addition, the first segment 58 is preferably longer than the second segment 59 as is best illustrated in FIG. 6 of the drawings. The first segment 58 and the second segment 59 are preferably comprised of a straight structures, however various other structures may be utilized. The first segment 58 and the second segment 59 are preferably molded as a single unit, however it can be appreciated that the loop member 50 may be comprised of a plurality of components secured together.

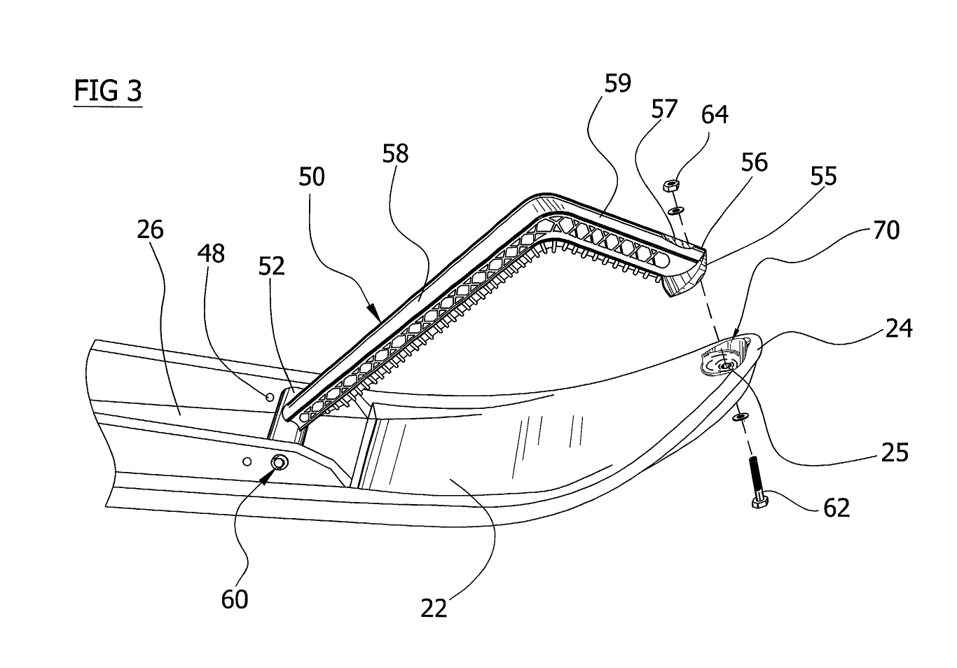

The loop member 50 preferably has a first end 52 and a second end 56 as shown in FIG. 3 of the drawings. The first end 52 of the loop member 50 is attached to the middle portion 26 preferably in a pivotal/movable manner by the usage of a first fastener 60 extend through a first aperture within the first end 52 and the receiving apertures 48 with a securing nut attached thereto. However, the first end 52 may be non-movably attached to the middle portion 26 of the elongate body 20. In addition, the first end 52 may be attached to the middle portion 26 of the elongate body 20 either directly or by a bracket assembly.

The first end 52 of the loop member 50 may be comprised of various structures other than the tubular structure illustrated within FIGS. 1 through 3 of the drawings. The first end 52 is preferably formed to fit between the members 42, 44 of the saddle portion 40 with a first fastener 60 extending through the appropriate receiving apertures 48 and a first aperture within the first end 52. The first aperture 54 may have various shapes and sizes as can be appreciated to allow for the movement or non-movement of the second end 56. It can be appreciated that the first end 52 may be nonmovably or movably secured within the middle portion 26 of the elongate body 20 to achieve various results. A nut and washer, or similar locking means, are secured about the threaded portion of the first fastener 60 for securing the first end 52 of the loop member 50 to the middle portion 26 of the elongate body 20. The first end 52 may be secured by various other securing means as may be suitable for usage upon the elongate body 20.

D. Loop Member Pivotal/Movable Connection—Second End

The second end 56 of the loop member 50 is preferably pivotally and movably attached to the front end 24 of the elongate body 20 for reducing interference with the movement and flexing of the loop member 50. The second end 56 of the loop member 50 has a second aperture 57 extending through thereof at a forward-downward angle as shown in FIG. 6 of the drawings. The second aperture 57 is substantially aligned with the front aperture 25 within the front end 24 of the elongate body 20 when the second end 56 of the loop member 50 is attached within the receiver cavity. As shown in FIG. 6 of the drawings, the second aperture 57 is preferably recessed a finite distance for receiving a mount nut 64 that is secured to the threaded portion of the second fastener 62. It can be appreciated that various other securing means may be utilized to secure the second end 56 of the loop member 50 to the front portion 22 of the elongate body 20.

The second end 56 of the loop member 50 may have various shapes and structures that allow for pivotal/movable attachment thereof to the front end 24 of the elongate body 20. The second end 56 preferably has a curved end 55 that corresponds substantially in shape with the inner surface of the receiver cavity 70 as best illustrated in FIGS. 3 through 7 of the drawings. The curved end 55 may have a constant radius or differing radii within.

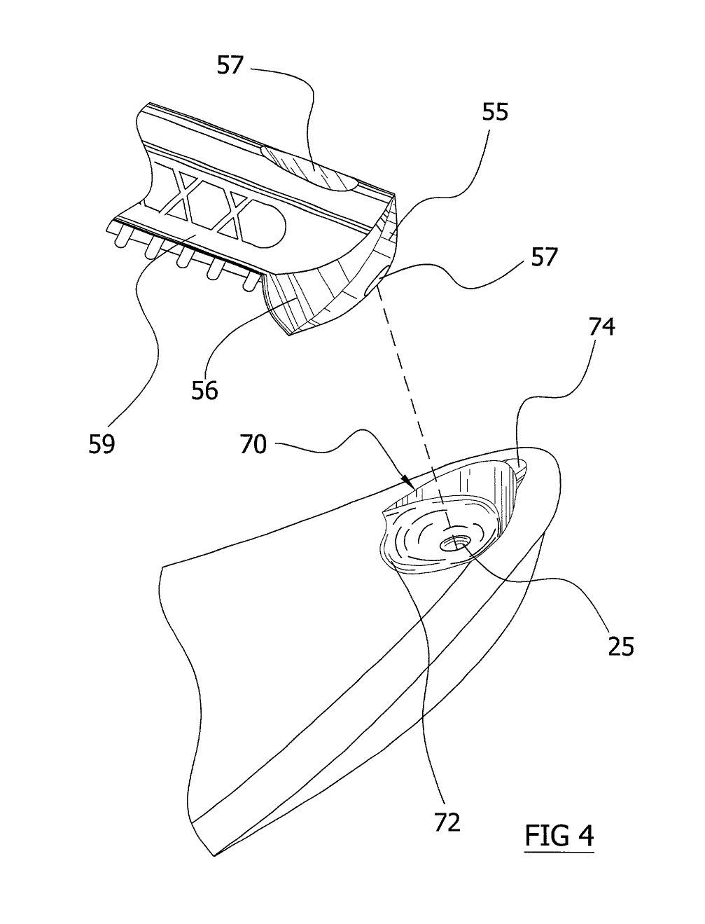

As shown in FIGS. 3 through 7 of the drawings, the receiver cavity 70 extends into the upper surface of the front end 24 of the elongate body 20. The receiver cavity 70 is preferably formed to correspond to the surface of the curved end 55. The receiver cavity 70 may have a constant radius or differing radii within similar to the curved end 55 of the loop member 50. As shown in FIG. 4 of the drawings, a rear cutout 72 and a front cutout 74 may extend into the receiver cavity 70 to allow for additional pivoting and movement of the second end 56 during flexing of the loop member.

The front aperture 25 within the front end 24 is preferably broader in diameter than the second fastener 62 for allowing movement of the second fastener 62 when the second end 56 of the loop member 50 is pivoted within the receiver cavity 70. The front aperture 25 is also preferably centrally positioned within the receiver cavity 70 as best illustrated in FIGS. 4 through 7 of the drawings. Using a front aperture 25 that provides a snug fit about the second fastener 62 can significantly reduce the movement of the second end 56 of the loop member 50.

The second aperture 57 is also preferably larger in diameter than the second fastener 62 to allow for side to side movement of the second fastener 62 within the second aperture 57. Using a second aperture 57 that provides a snug fit about the second fastener 62 can significantly reduce the movement of the second end 56 of the loop member 50. It should be noted that the second fastener 62 is preferably secured tightly within the apertures 25, 57 so that the curved end 55 is held tightly and adjacent to the receiver cavity 70 at all times.

The resulting product of the ski is a resilient elongate body 20 having a front portion 22 and a loop member 50 attached to the front portion 22 thereof. When the elongate body 20 is secured to the snowmobile or like vehicle, the user is able to operate the vehicle upon a surface covered with snow. When the front portion 22 of the elongate body 20 encounters an object such as a rock or snowdrift, the front portion 22 bends rearwardly along with the loop member 50. As the front portion 22 bends, the curved end 55 is allowed to pivot and move relatively freely within the receiver cavity 70 thereby reducing interference with the movement of the loop member 50. The loop member 50 therefore does not provide any rigid support or interference to the front portion 22 of the elongate body 20 when encountering an object and therefore allows the front portion 22 to bend throughout freely without significant interference.

As to a further discussion of the manner of usage and operation of the present invention, the same should be apparent from the above description. Accordingly, no further discussion relating to the manner of usage and operation will be provided. Although the present invention has been described in considerable detail with reference to certain preferred versions thereof, other versions are possible. It should also be stated at this point that although this invention is described in the context of a snowmobile, this invention would be equally useful on airplane skis, BOMBARDIERS, SNO-SCOOTS, and other similar vehicles.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A flexible ski loop system, comprising:
an elongate body comprised of a resilient material having a front portion having a front end, a middle portion, and a rear portion having a rear end;
a receiver cavity having a curved structure extending into an upper surface of said front end;
a front aperture extending through said front end within said receiver cavity;
a loop member having a first end and a second end, wherein said first end is secured to said middle portion of said elongate body;
wherein said second end of said loop member is comprised of a curved end that substantially reflects a shape of said receiver cavity;
a first aperture extending through said second end of said loop member; and
a fastener extending through said front aperture and said first aperture, wherein a mount nut is attached to said fastener for securing said second end within said receiver cavity in a movable manner.

2. The flexible ski loop system of claim 1, wherein said elongate body is comprised of an ultra high molecular weight plastic.

3. The flexible ski loop system of claim 1, wherein said receiver cavity has a plurality of radii.

4. The flexible ski loop system of claim 1, wherein said receiver cavity has a substantially constant radius.

5. The flexible ski loop system of claim 1, wherein said curved end has a plurality of radii.

6. The flexible ski loop system of claim 1, wherein said curved end has a substantially constant radius.

7. The flexible ski loop system of claim 1, wherein said front aperture has an inner diameter larger than an outer diameter of a shaft of said fastener for allowing radial movement of the fastener within the front aperture.

8. The flexible ski loop system of claim 7, wherein said first aperture has an inner diameter larger than an outer diameter of a shaft of said fastener for allowing radial movement of the fastener within the front aperture.

9. The flexible ski loop system of claim 1, wherein said loop member is comprised of a first segment and a second segment, wherein said first segment and said second segment have an angle between thereof greater than 90 degrees.

10. The flexible ski loop system of claim 1, wherein said loop member is comprised of a first segment and a second segment, wherein said first segment is comprised of a relatively straight structure and wherein said second segment is comprised of a relatively straight structure, and wherein said first segment and said second segment have an angle between thereof greater than 90 degrees.

11. The flexible ski loop system of claim 1, wherein said first aperture has an inner diameter larger than an outer diameter of a shaft of said fastener for allowing radial movement of the fastener within the front aperture.

12. The flexible ski loop system of claim 1, wherein said receiver cavity includes a rear cutout portion.

13. The flexible ski loop system of claim 1, wherein said receiver cavity includes a front cutout portion.

14. The flexible ski loop system of claim 1, wherein said first aperture includes a recessed portion for receiving said mount nut within.

15. The flexible ski loop system of claim 1, wherein said fastener has a head portion and a shaft portion, wherein said head portion is adjacent a lower surface of said front end with said shaft portion extending through said front aperture and then through said first aperture to be secured by said mount nut.

16. The flexible ski loop system of claim 1, wherein said front aperture is centrally positioned within said receiver cavity.

17. The flexible ski loop system of claim 1, wherein said first aperture extends through said second end of said loop member at a downward angle.

18. The flexible ski loop system of claim 1, wherein said receiver cavity has a radius larger than 1 inch.

19. The flexible ski loop system of claim 1, wherein said curved end of said loop member is mirrors said receiver cavity in an identical manner.

20. The flexible ski loop system of claim 1, wherein said fastener secures said second end of said loop member to said front end of said elongate body in a taut manner so that said curved end is positioned substantially adjacent to an inner surface of said receiver cavity.
